(19) United States
(12) Patent Application Publication
(10) Pub. No.: US 2007/0102246 A1
(43) Pub. Date: May 10, 2007

(54) Hub hat for bolt-on brake rotor, associated brake assembly and associated methods

(76) Inventor: Christopher L. Carroll, Deland, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/272,205

(22) Filed: Nov. 10, 2005

(51) Int. Cl. B60T 1/06

(52) U.S. Cl. 188/17

(57) ABSTRACT

The bolt-on disc brake assembly includes a hub hat that can be used with off the shelf rotors and doesn't require any welding to complete a disc brake conversion. Thea hub hat is for mounting a bolt-on brake rotor to a wheel hub on an axle shaft assembly. The hub hat includes an annular hub plate with circumferentially spaced through-holes to receive wheel studs of the wheel hub, an annular rotor plate with circumferentially spaced through-holes to receive bolts for bolting on the brake rotor, and a circular-cylindrical hub housing connected between the annular hub plate and the annular rotor plate.

### FIELD OF THE INVENTION

The present invention relates to the field of auto/truck parts, and, more particularly, to brake assemblies and related methods.

### BACKGROUND OF THE INVENTION

The average pick-up truck utilizes ½ ton axles with a 29″ to 31″ tall tire on a 7″ wide wheel. These axles were designed to withstand typical loads. As off-road enthusiasts began mounting larger tires and wider wheels on these trucks the additional leverage often resulted in axle failure. This led to the use of stronger ¾ & 1 ton axles. Some off-road trucks began using 48″ tall tires with a 25″ tread width mounted on 20″ wide wheels. The leverage factor simply proved too great for even the strongest 1 ton axles. The spindles, steering knuckles and king pins were never designed for these loads. So, many off-road enthusiasts began using ‘Rockwell 2½ ton’ military troop transport axles. In addition to having stronger knuckles and king pins, these axles had a third member which was inserted from the top side of the axle housing (“Top Loader”) which included a 90 degree pinion thus reducing driveline angles. These axles also were equipped with a 6.72:1 gear ratio which worked very well with the 48″ tire combo.

However, this military running gear, as well as other after-market heavier duty axle assemblies, includes drum brakes. Disc brakes are superior to drums in numerous ways. They offer better stopping power and are self cleaning in mud and water, where drums tend to pack up with dirt and moisture. The rotor of a disc brake assembly is exposed to air which helps keep them cooler for less fade. Disc brake assemblies also weigh less and are easier to service than drum brakes. For example, typical drum brakes include various springs and a manual adjuster which are susceptible to failure under certain off road conditions.

So, various disc brake conversion kits are available. However, these kits typically include specialized rotors including welded-on hub hats and various brackets to complete the conversion. There is a need for a bolt-on disc brake assembly that can be used with off the shelf rotors and doesn't require any welding.

### SUMMARY OF THE INVENTION

In view of the foregoing background, it is therefore an object of the present invention to provide a bolt-on disc brake assembly including a hub hat that can be used with off the shelf rotors and doesn't require any welding to complete a disc brake conversion.

This and other objects, features, and advantages in accordance with the present invention are provided by a hub hat for mounting a bolt-on brake rotor to a wheel hub on an axle shaft assembly. The hub hat includes an annular hub plate with circumferentially spaced through-holes to receive wheel studs of the wheel hub, an annular rotor plate with circumferentially spaced through-holes to receive bolts for bolting on the brake rotor, and a circular-cylindrical hub housing connected between the annular hub plate and the annular rotor plate.

The circular-cylindrical hub housing may include a first open end coupled to the annular hub plate, and a second open end opposite the first open end and coupled to the annular rotor plate. The annular hub plate has an inner diameter and an outer diameter, and the annular rotor plate has an inner diameter and an outer diameter. The first open end of the circular cylindrical hub housing may include a first stepped portion fitted within the inner diameter of the annular hub plate, and the second open end of the circular cylindrical hub housing may include a second stepped portion fitted within the inner diameter of the annular rotor plate.

The circular-cylindrical hub housing may include a first hub housing portion adjacent the annular hub plate and having a first outer diameter, a second hub housing portion adjacent the annular rotor plate and having a second outer diameter less than the first outer diameter, and a transition portion, such as a beveled portion, between the first and second hub housing portions.

Objects, features, and advantages in accordance with the present invention are provided by a bolt-on brake assembly to be mounted on an axle shaft assembly, and including a bolt-on brake rotor, a wheel hub including wheel studs, and a hub hat to mount the bolt-on brake rotor to the wheel hub. The hub hat includes an annular hub plate including circumferentially spaced through-holes to receive the wheel studs of the wheel hub, an annular rotor plate including circumferentially spaced through-holes to receive bolts for bolting on the brake rotor, and a circular-cylindrical hub housing connected between the annular hub plate and the annular rotor plate. A brake caliper is mounted adjacent the bolt-on brake rotor, and a brake caliper mounting bracket may be included to mount the brake caliper to the axle shaft assembly adjacent the bolt-on brake rotor.

Objects, features, and advantages in accordance with the present invention are also provided by a method for mounting a bolt-on brake rotor to a wheel hub on an axle shaft assembly. The method includes providing a hub hat by forming an annular hub plate with circumferentially spaced through-holes to receive wheel studs of the wheel hub, forming an annular rotor plate with circumferentially spaced through-holes to receive bolts for bolting on the brake rotor, and connecting the annular hub plate and the annular rotor plate with a circular-cylindrical hub housing.

The method may also include bolting the bolt-on brake rotor on the annular rotor plate, mounting the hub hat to the wheel hub via the wheels studs, and mounting the hub hat and wheel hub on the axle shaft assembly. Also, a brake caliper may be mounted adjacent the bolt-on brake rotor via a mounting bracket connected to the axle shaft assembly.

### BRIEF DESCRIPTION OF THE DRAWINGS

FIG. 1 is a plan view of a hub hat and brake rotor in accordance with the present invention.

FIG. 2 is a side view of the annular hub plate of the hub hat of FIG. 1.

FIG. 3 is is a side view of the annular rotor plate of the hub hat of FIG. 1.

FIG. 4A is a side view of the circular-cylindrical hub housing of the hub hat of FIG. 1.

FIG. 4B is a top view of the circular-cylindrical hub housing of FIG. 4A.

FIG. 5A is a side view of the brake rotor of FIG. 1.

FIG. 5B is a top view of the brake rotor of FIG. 5A.

FIG. 6 is a side view of a brake caliper mounting bracket in accordance with the invention.

FIG. 7 is a top view of the bolt-on brake assembly and wheel hub mounted on an axle shaft assembly in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

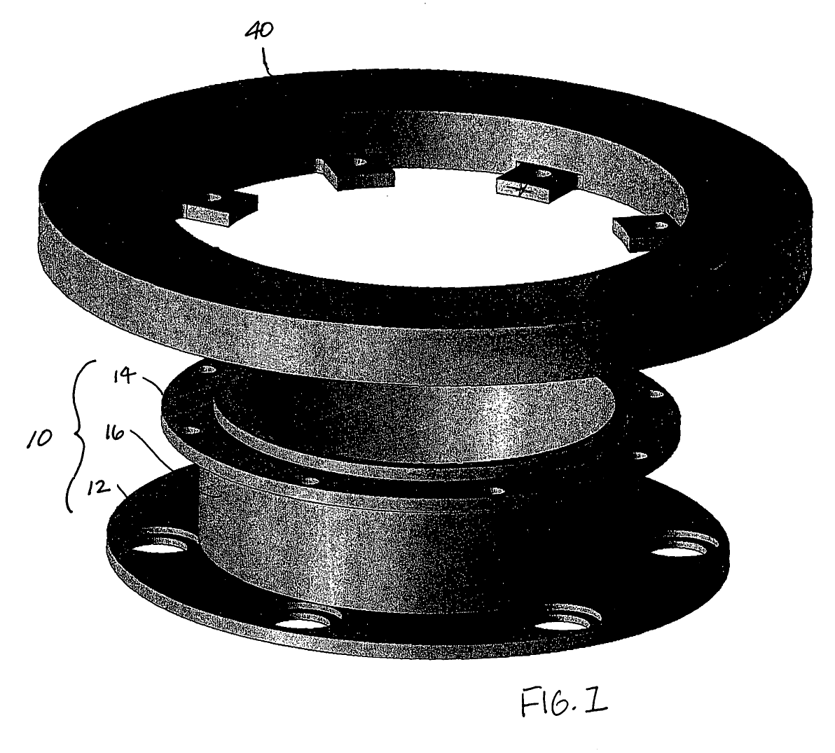

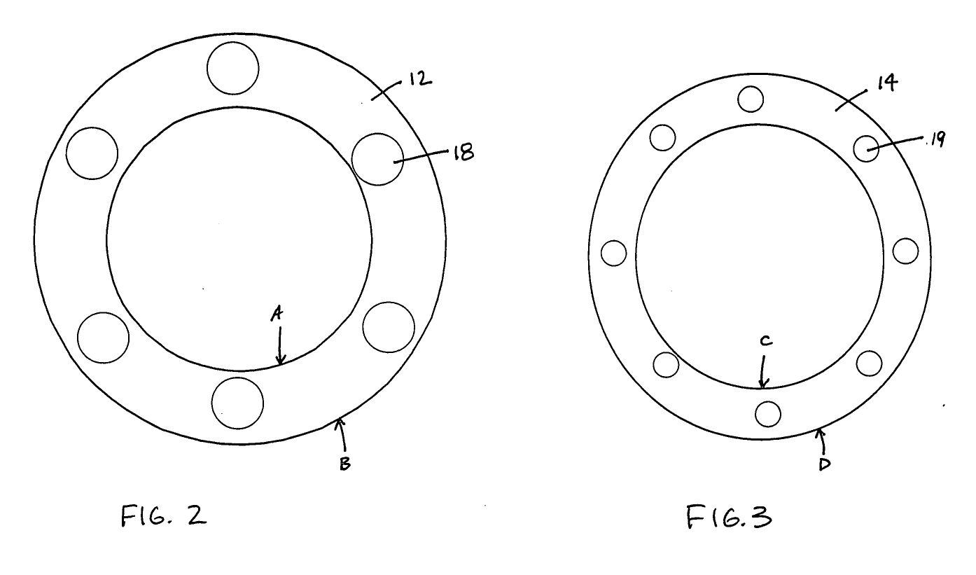

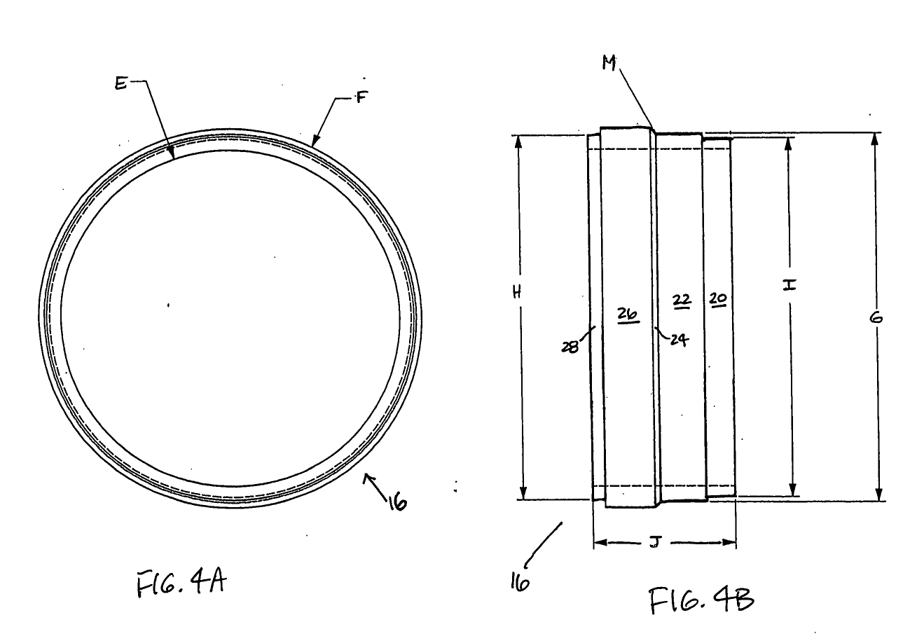

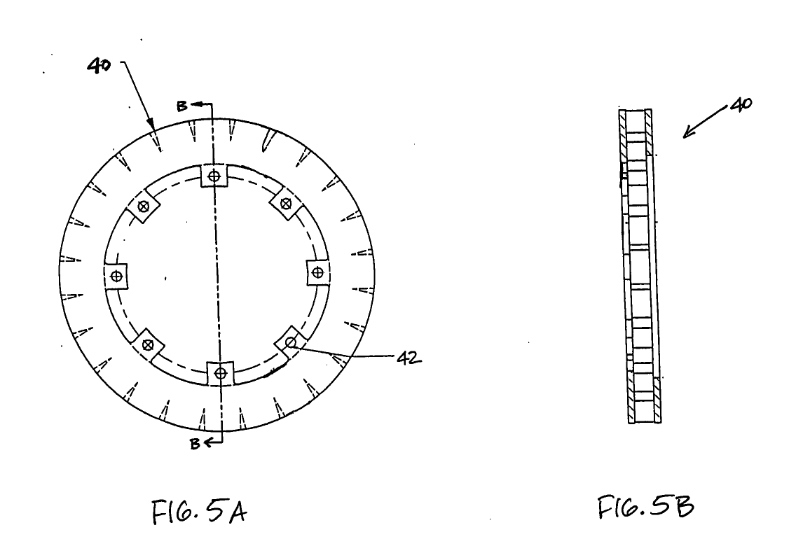

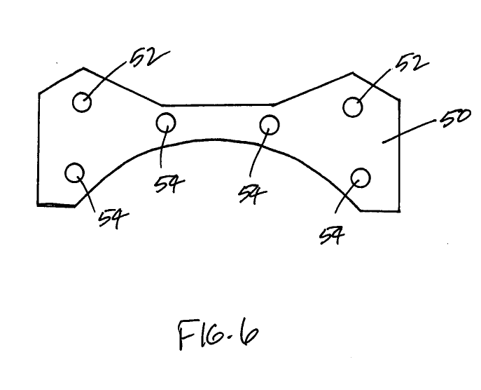

Referring to FIGS. 1-7, a bolt-on disc brake assembly 90 including a hub hat 10 will be described. The bolt-on disc brake assembly 90 including a hub hat 10 can be used with off the shelf brake rotors and doesn't require any welding to complete a disc brake conversion. The hub hat 10 is for mounting a bolt-on brake rotor 40 to a wheel hub 80 on an axle shaft assembly 60. The hub hat 10 includes an annular hub plate 12 with circumferentially spaced through-holes 18 to receive wheel studs 82 of the wheel hub 80. The hub hat 10 also includes an annular rotor plate 14 with circumferentially spaced through-holes 19 to receive bolts 44 for bolting on the brake rotor 40 via brake rotor mounting holes 42. Furthermore, a circular-cylindrical hub housing 16 is connected between the annular hub plate 12 and the annular rotor plate 14.

The circular-cylindrical hub housing 16 may include a first open end coupled to the annular hub plate 12, and a second open end opposite the first open end and coupled to the annular rotor plate 14. The annular hub plate 12 has an inner diameter A, e.g. about 7.105 inches, and an outer diameter B, e.g. about 10.5 inches, and the annular rotor plate 14 has an inner diameter C, e.g. about 7.0 inches, and an outer diameter D, e.g. about 8.35 inches. The first open end of the circular cylindrical hub housing 16 may include a first stepped portion 28, having a diameter H (e.g. about 7.1 inches), fitted within the inner diameter A of the annular hub plate 12, and the second open end of the circular cylindrical hub housing may include a second stepped portion 20, having a diameter I (e.g. about 6.99 inches) fitted within the inner diameter C of the annular rotor plate 14. The annular hub plate 12 and the annular rotor plate 14 are each preferably mounted via a precision fit with respective stepped portions 28, 20. The annular hub plate 12, annular rotor plate 14 and cylindrical hub housing 16 are preferably secured to each other via respective welds to provide an integrated hub hat 10 to the consumer.

The circular-cylindrical hub housing 16 may include a first hub housing portion 26 adjacent the annular hub plate 12 and having a first outer diameter F (e.g. about 7.4 inches), a second hub housing portion 22 adjacent the annular rotor plate 14 and having a second outer diameter G (e.g. about 7.18 inches) less than the first outer diameter F, and a transition portion 24, such as a beveled portion having an angle M, between the first and second hub housing portions. The transition portion 24 provides the clearance for easing the installation of the wheel studs 82 and/or rotor mounting bolts 44. The width J of the cylindrical hub housing 16 may be about 2.75 inches, for example.

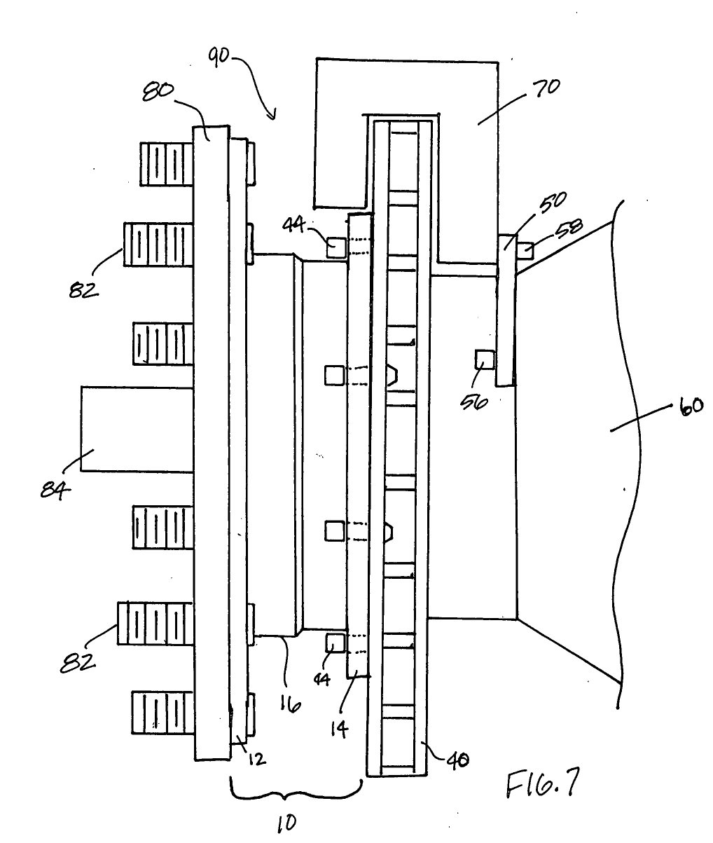

The bolt-on brake assembly 90 is designed to be mounted on an axle shaft assembly 60, such as Rockwell 2½ ton military gear. Of course the hub hat 10 and bolt-on brake assembly 90 of the present invention may be used with any axle assembly and wheel hub combination that can be converted and/or upgraded to disc brakes. The bolt-on brake assembly 90 includes the bolt-on brake rotor 40, a wheel hub 80 including wheel studs 82, and the hub hat 10 to mount the bolt-on brake rotor 40 to the wheel hub 80. A brake caliper 70 (FIG. 7) is mounted adjacent the bolt-on brake rotor 40, and a brake caliper mounting bracket 50 (FIGS. 6 and 7) may be included to mount the brake caliper, via caliper mounting holes 52, axle assembly mounting holes 54 and bolts 56, 58, to the axle shaft assembly 60 adjacent the bolt-on brake rotor 40.

A method aspect of the invention is directed to mounting the bolt-on brake rotor 40 to the wheel hub 80 on an axle shaft assembly 60. The method includes providing a hub hat 10 by forming the annular hub plate 12 with circumferentially spaced through-holes 18 to receive wheel studs 82 of the wheel hub 80, forming the annular rotor plate 14 with circumferentially spaced through-holes 19 to receive bolts 44 for bolting on the brake rotor 40, and connecting the annular hub plate and the annular rotor plate with a circular-cylindrical hub housing 16.

The method may also include bolting the bolt-on brake rotor 40 on the annular rotor plate 14, mounting the hub hat 10 to the wheel hub 80 via the wheels studs 82, and mounting the hub hat 10 and wheel hub 80 on the axle shaft assembly 60, e.g. on spindle 84. Also, the brake caliper 70 may be mounted adjacent the bolt-on brake rotor 40 via the mounting bracket 50 connected to the axle shaft assembly 60.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A hub hat for mounting a bolt-on brake rotor to a wheel hub on an axle shaft assembly, the hub hat comprising:
an annular hub plate including circumferentially spaced through-holes to receive wheel studs of the wheel hub;
an annular rotor plate including circumferentially spaced through-holes to receive bolts for bolting on the brake rotor; and
a circular-cylindrical hub housing connected between the annular hub plate and the annular rotor plate.

2. The hub hat according to claim 1 wherein the circular-cylindrical hub housing includes a first open end coupled to the annular hub plate, and a second open end opposite the first open end and coupled to the annular rotor plate.

3. The hub hat according to claim 2 wherein the annular hub plate has an inner diameter and an outer diameter; and wherein the first open end of the circular cylindrical hub housing includes a stepped portion fitted within the inner diameter of the annular hub plate.

4. The hub hat according to claim 2 wherein the annular rotor plate has an inner diameter and an outer diameter; and wherein the second open end of the circular cylindrical hub housing includes a stepped portion fitted within the inner diameter of the annular rotor plate.

5. The hub hat according to claim 2 wherein the annular hub plate has an inner diameter and an outer diameter, and the annular rotor plate has an inner diameter and an outer diameter; and wherein the first open end of the circular cylindrical hub housing includes a first stepped portion fitted within the inner diameter of the annular hub plate, and the second open end of the circular cylindrical hub housing includes a second stepped portion fitted within the inner diameter of the annular rotor plate.

6. The hub hat according to claim 2 wherein the circular-cylindrical hub housing comprises:
a first hub housing portion adjacent the annular hub plate and having a first outer diameter;
a second hub housing portion adjacent the annular rotor plate and having a second outer diameter less than the first outer diameter; and
a transition portion between the first and second hub housing portions.

7. The hub hat according to claim 6 wherein the transition portion comprises a beveled portion.

8. A bolt-on brake assembly to be mounted on an axle shaft assembly, and comprising:
a bolt-on brake rotor;
a wheel hub including wheel studs;
a hub hat to mount the bolt-on brake rotor to the wheel hub, and comprising
an annular hub plate including circumferentially spaced through-holes to receive the wheel studs of the wheel hub,
an annular rotor plate including circumferentially spaced through-holes to receive bolts for bolting on the brake rotor, and
a circular-cylindrical hub housing connected between the annular hub plate and the annular rotor plate.

9. The bolt-on brake assembly according to claim 8, further comprising a brake caliper to be mounted adjacent the bolt-on brake rotor.

10. The bolt-on brake assembly according to claim 9, further comprising a brake caliper mounting bracket to mount the brake caliper to the axle shaft assembly adjacent the bolt-on brake rotor.

11. The bolt-on brake assembly according to claim 8, wherein the circular-cylindrical hub housing includes a first open end coupled to the annular hub plate, and a second open end opposite the first open end and coupled to the annular rotor plate.

12. The bolt-on brake assembly according to claim 11, wherein the annular hub plate has an inner diameter and an outer diameter, and the annular rotor plate has an inner diameter and an outer diameter; and wherein the first open end of the circular cylindrical hub housing includes a first stepped portion fitted within the inner diameter of the annular hub plate, and the second open end of the circular cylindrical hub housing includes a second stepped portion fitted within the inner diameter of the annular rotor plate.

13. The bolt-on brake assembly according to claim 8 wherein the circular-cylindrical hub housing comprises:
a first hub housing portion adjacent the annular hub plate and having a first outer diameter;
a second hub housing portion adjacent the annular rotor plate and having a second outer diameter less than the first outer diameter; and
a transition portion between the first and second hub housing portions.

14. The bolt-on brake assembly according to claim 13 wherein the transition portion comprises a beveled portion.

15. A method for mounting a bolt-on brake rotor to a wheel hub on an axle shaft assembly, the method comprising:
providing a hub hat including
forming an annular hub plate with circumferentially spaced through-holes to receive wheel studs of the wheel hub,
forming an annular rotor plate with circumferentially spaced through-holes to receive bolts for bolting on the brake rotor, and
connecting the annular hub plate and the annular rotor plate with a circular-cylindrical hub housing.

16. The method according to claim 15, further comprising:
bolting the bolt-on brake rotor on the annular rotor plate;
mounting the hub hat to the wheel hub via the wheels studs; and
mounting the hub hat and wheel hub on the axle shaft assembly.

17. The method according to claim 16, further comprising mounting a brake caliper adjacent the bolt-on brake rotor via a mounting bracket connected to the axle shaft assembly.

18. The method according to claim 15 wherein the circular-cylindrical hub housing includes a first open end coupled to the annular hub plate, and a second open end opposite the first open end and coupled to the annular rotor plate.

19. The hub hat according to claim 18 wherein the annular hub plate has an inner diameter and an outer diameter, and the annular rotor plate has an inner diameter and an outer diameter; and wherein the first open end of the circular cylindrical hub housing includes a first stepped portion fitted within the inner diameter of the annular hub plate, and the second open end of the circular cylindrical hub housing includes a second stepped portion fitted within the inner diameter of the annular rotor plate.

20. The method according to claim 15 wherein the circular-cylindrical hub housing comprises:
a first hub housing portion adjacent the annular hub plate and having a first outer diameter;
a second hub housing portion adjacent the annular rotor plate and having a second outer diameter less than the first outer diameter; and
a transition portion between the first and second hub housing portions.
